(19) United States
(12) Patent Application Publication
(10) Pub. No.: US 2009/0111398 A1
(43) Pub. Date: Apr. 30, 2009

(54) Transmitter and transmission method

(75) Inventors: Marko Leukkunen, Oulu (FI); Kauko Heinikoski, Oulu (FI)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignee: NOKIA CORPORATION

(21) Appl. No.: 12/222,488

(22) Filed: Aug. 11, 2008

(30) Foreign Application Priority Data
Oct. 30, 2007 (FI) 20075763

(51) Int. Cl. H04L 25/00

(52) U.S. Cl. 455/114.2

(57) ABSTRACT

There is provided an apparatus, having a first local oscillator generate a first oscillation signal, a first mixer generating a transmit signal by mixing an input signal and the first oscillation signal, an observation receiver receiving a portion of the transmit signal, and applying, in a first operation mode of the apparatus, the received portion of the transmit signal such that a transmit signal component on a frequency of the first oscillation signal falls into a band-pass frequency of the observation receiver, and shift, in a second operation mode of the apparatus, the received portion of the transmit signal such that an oscillation leakage signal component of the first oscillation signal falls into the band-pass frequency of the observation receiver; and a compensation unit generating a compensation signal based on the band-pass signal of the observation receiver for compensation of the input signal.

### FIELD

The invention relates to a radio transmitter and a transmission method.

### BACKGROUND

In a radio transmitter applying IQ-modulation, local oscillator (LO) leakage is due to errors in the I and Q branches. One means of cancelling the LO leakage is to null it during the manufacture of the transmitter. However, this approach does not take into account aging and the effect environmental factors may have on the leakage. It is thus clear that improved ways of cancelling LO leakage are needed.

### SUMMARY

An object of the present invention is to provide an apparatus, comprising a first local oscillator configured to generate a first oscillation signal, a first mixer configured to generate a transmit signal by mixing an input signal and the first oscillation signal, an observation receiver configured to receive a portion of the transmit signal, apply, in a first operation mode of the apparatus, the received portion of the transmit signal in the observation receiver such that a transmit signal component on a frequency of the first oscillation signal present in the received portion of the transmit signal falls into a band-pass frequency of the observation receiver, shift, in a second operation mode of the apparatus, the received portion of the transmit signal such that an oscillation leakage signal component of the first oscillation signal present in the received portion of the transmit signal falls into the band-pass frequency of the observation receiver; and which apparatus comprises a compensation unit configured to generate a compensation signal on the basis of the band-pass signal of the observation receiver for compensation of the input signal.

In another aspect, there is provided an apparatus, comprising means for generating a first oscillation signal, means for generating a transmit signal by mixing an input signal and the first oscillation signal, means for receiving a portion of the transmit signal, means for applying, in a first operation mode of the apparatus, the received portion of the transmit signal in the observation receiver such that a transmit signal component on a frequency of the first oscillation signal present in the received portion of the transmit signal falls into a band-pass frequency of the observation receiver, means for shifting, in a second operation mode of the apparatus, the received portion of the transmit signal such that an oscillation leakage signal component of the first oscillation signal present in the received portion of the transmit signal falls into the band-pass frequency of the observation receiver, and means for generating a compensation signal on the basis of the band-pass signal of the observation receiver for compensation of the input signal.

In another aspect, there is provided a method, comprising generating a first oscillation signal, generating a transmit signal by mixing an input signal and the first oscillation signal, receiving a portion of the transmit signal in an observation receiver, applying, in a first operation mode, the received portion of the transmit signal such that a transmit signal component on a frequency of the first oscillation signal present in the received portion of the transmit signal falls into a band-pass frequency of the observation receiver, shifting, in a second operation mode of the apparatus, the received portion of the transmit signal such that an oscillation leakage signal component of the first oscillation signal present in the received portion of the transmit signal falls into the band-pass frequency of the observation receiver, and generating a compensation signal on the basis of the band-pass signal of the observation receiver for compensation of the input signal.

In another aspect, there is provided a computer-readable medium having computer-executable components comprising generating a first oscillation signal, generating a transmit signal by mixing an input signal and the first oscillation signal, receiving a portion of the transmit signal in an observation receiver, applying, in a first operation mode, the received portion of the transmit signal such that a transmit signal component on a frequency of the first oscillation signal present in the received portion of the transmit signal falls into a band-pass frequency of the observation receiver, shifting, in a second operation mode of the apparatus, the received portion of the transmit signal such that an oscillation leakage signal component of the first oscillation signal present in the received portion of the transmit signal falls into the band-pass frequency of the observation receiver, and generating a compensation signal on the basis of the band-pass signal of the observation receiver for compensation of the input signal.

### DRAWINGS

In the following the invention will be described in greater detail by means of preferred embodiments with reference to the accompanying drawings, in which

FIG. 1 shows an embodiment of an apparatus;

FIG. 2 shows another embodiment of an apparatus;

FIG. 3 shows still another embodiment of an apparatus;

FIG. 4 shows still another embodiment of an apparatus;

FIG. 5 shows an embodiment of a method; and

FIG. 6 highlights the operation in frequency domain.

### DESCRIPTION

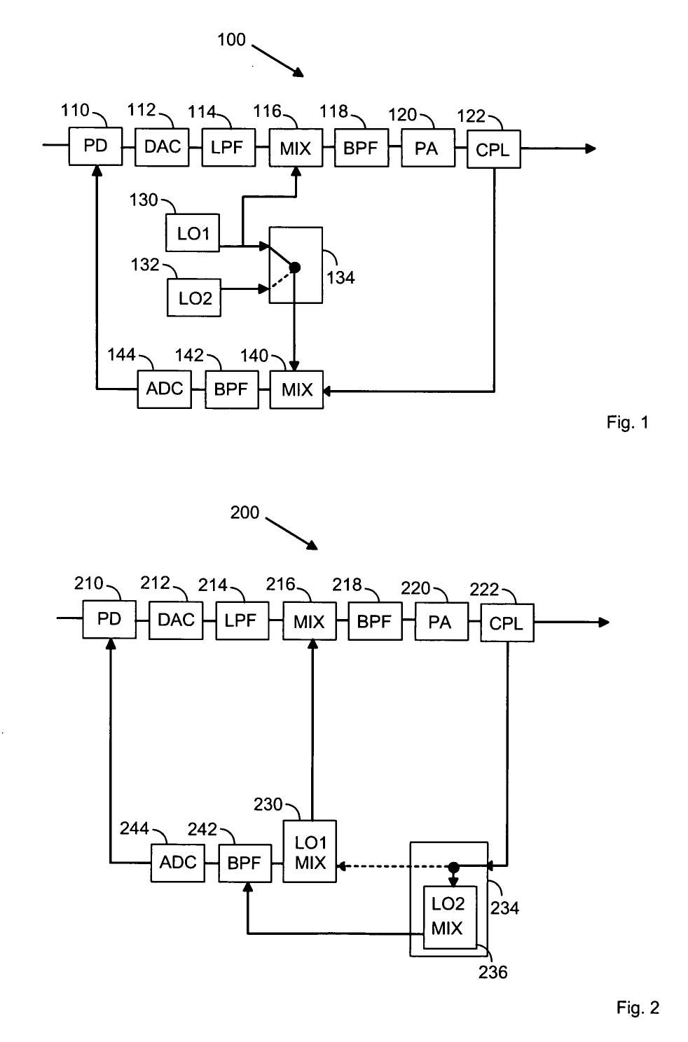

FIG. 1 is shows an embodiment of a transmitter 100 according to the invention. The transmitter may be part of a mobile station or a base station of a radio system, for instance. In the embodiment of FIG. 1, the transmitter is a predistortion transmitter. Predistortion is a technique for improving the linearity of radio transmitter amplifiers. In a predistortion circuit, the amplifier's gain and phase characteristics are modelled, and corrected. Practically, inverse distortion is introduced to an input of an amplifier, thereby cancelling non-linearity of the transmitter.

In the following, the invention is mainly explained in conjunction with a predistortion transmitter. However, the invention is not limited to predistortion transmitters but may also be applied in other transmitter types having an observation/feedback path. Thus, instead of or in addition to a predistortion feedback path, the transmitter may include a feedback path for observation of power levels in the transmit path or measurement of timings between a plurality of transmit paths, for instance.

In FIG. 1, the transmitter has an input at the input of the predistortion compensation unit 110 that receives a complex digital baseband signal to be transmitted by the transmitter. The predistortion compensation unit applies an inverse distortion to the signal compared to the distortion caused by the non-linearity of the power amplifier 120.

The output of the predistortion unit is passed on to a digital-to-analogue converter unit 112, in which the digital I and Q signals are converted to analogue signals. A low pass filter 114 filters undesired signal components, which are introduced by the digital to analogue conversion unit 112.

In the mixer 116, the I and Q signals output by the low-pass filter 114 are mixed with a first oscillation signal from the first local oscillator 130. The output of the mixer 116 is a signal on a radio frequency (RF) to be transmitted by the transmitter.

A band-pass filter 118 filters undesired components introduced by the mixer 116. The output of the band-pass filter is forwarded to a power amplifier 120, which amplifies the signal for transmission. The components 110 to 120 form a transmission path of the transmitter.

A coupler 126 is coupled to the output of the power amplifier 120. One output of the coupler is forwarded to radio frequency modules for radio transmission (not shown) and the second output is coupled to an observation receiver of the transmitter. Practically, the observation receiver includes a feedback path including the components 140 to 144.

The first unit in the observation receiver/path is a mixer 140 for down-converting the transmit signal received from the coupler 122. For the down-conversion, the mixer receives an oscillation signal either from a first local oscillator 130 or a second local oscillator 132. The transmitter includes a mechanism 134 for selecting the source of the oscillation signal. In an embodiment, the mechanism is a switch. In another embodiment, the mechanism may based on attenuation of one of the signals. That is, the coupling may be such that both of the oscillation signal sources LO1, LO2 are connected to the mixer 140 all the time but one of the sources may be attenuated such that feeding of one of the signals only is allowed to the mixer.

In the embodiment of FIG. 1, the coupling mechanism 134 is a switch. The oscillation signal from the first oscillator 130 is continuously fed to the transmission path. However, the switch responsible for feeding an oscillation signal to the mixer 140 switches between the oscillation signal from the first oscillation unit 130 and the second oscillation unit 132. In FIG. 1, the switch 134 is coupled to the first oscillation unit 130, as shown by the solid line, such that the first oscillation signal is fed to the mixer 140. The dashed line from the switch to the second oscillation unit denotes that the switch has a potential to be connected to the second oscillation unit, thereby feeding the mixer 140 with the second oscillation signal.

The band-pass filter 142 filters undesired components of the down-converted signal and the analogue to digital converter 144 converts the signal into digital form, which is fed to the compensation unit 110.

When the mixer 140 is coupled to the first oscillation unit, the transmitter is in a first operation mode, in which mode the compensation unit 110 forms a compensation signal for compensation of the predistortion caused by the amplifier 120. In a second operation mode, when the mixer is coupled to the second oscillation unit, the compensation unit generates a compensation signal for compensation of a leakage signal generated by the first oscillation unit 130 to the transmit path. The compensation signal for the purpose of cancellation of the leakage signal is generated such that the second oscillation unit 132 generates an oscillation signal on such a frequency that the leakage signal is shifted to a band-pass frequency of the observation receiver and a compensation signal may then be generated of it in the compensation unit 110.

The compensation unit 110 compares, in the first operation mode, the signal to be transmitted by the predistortion unit with the signal received via the observation receiver. Ideally these signals should be the same. Based on the comparison, the predistortion unit calculates correction coefficients to be applied to the transmit signal such that the transmit signal and the feedback signal received via the feedback path would be as similar as possible. During the first operation mode, the compensation unit uses previously estimated and stored values for compensation of oscillation leakage.

In the second operation mode, the compensation unit 110 may use previously stored values for the compensation of the predistortion. In the second operation mode, the unit generates a compensation signal for the compensation of the oscillation leakage signal.

FIG. 2 shows another embodiment of a transmitter 200. The transmitter chain 210 to 222 corresponds to the transmitter chain 110 to 122 in FIG. 1. In FIG. 2, the switch 234 is placed into the observation path right after the coupler 222. The switch may, in a first operation mode, forward the transmit signal directly to the unit 230 shown by the dashed line. The unit 230 may be an integrated circuit including an oscillator (LO1) and a mixer. The unit 230 may also feed the first oscillating signal to the transmission path. In this operation mode, the same oscillation signal is applied in the transmit path and in the observation path, whereby this mode may be used for compensation of predistortion caused by the power amplifier 220.

In a second operation mode, the switch 234 may forward a portion of a transmit signal, extracted by the coupler 222, to the integrated circuit 236 including a second local oscillator (LO2) and a mixer for mixing the inputted transmit signal with the second oscillation signal. Upon mixing of the extracted transmit signal portion and the second oscillation signal, an LO leakage signal component present in the transmit signal portion falls into a band-pass frequency of the observation receiver. Thereby, in the second operation mode, the leakage signal passes the band-pass filter 242, and an inverse compensation signal to the leakage signal may be generated in the analogue to digital converter 244 and the compensation unit 210.

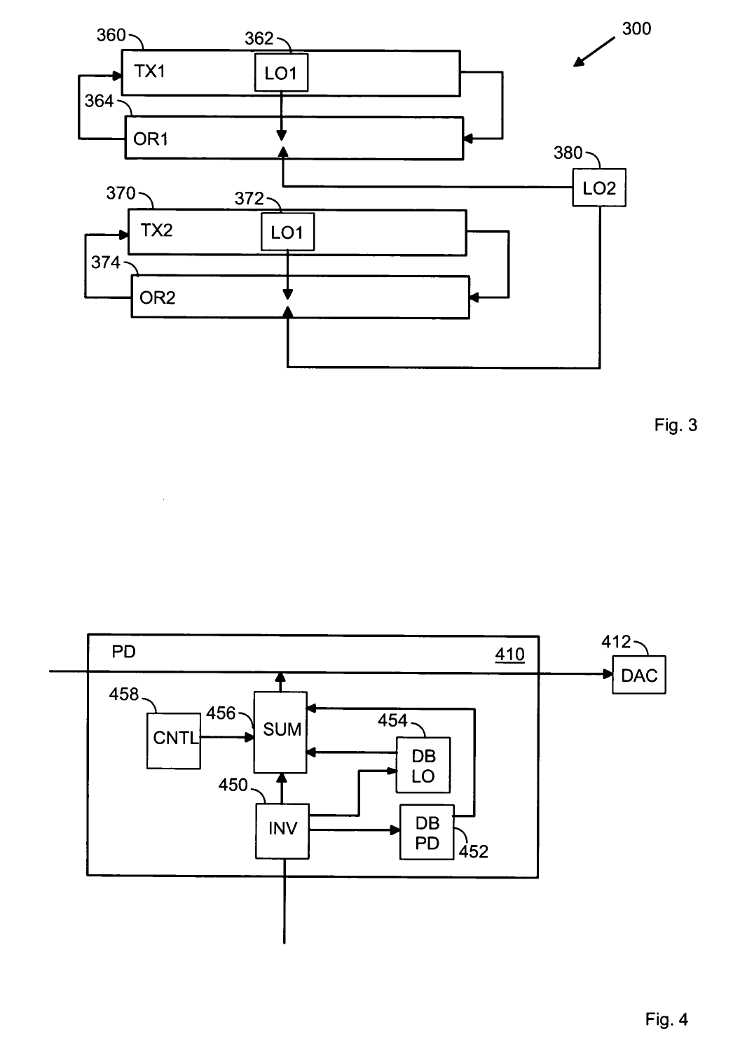

FIG. 3 shows an embodiment of a transmitter 300 having a plurality of transmit/observation paths. In the figure, two of these chains have been shown: the first path includes a first transmit path 360 and a first observation path 364 for observing one or more parameters in the first transmit path. A second transmit path 370 is observed by means of a second observation path 374.

In the embodiment of FIG. 3, the first local oscillator 362 provides a first oscillating signal to the transmit path 360. The first local oscillator 362 may be integrated into the same integrated circuit as a mixer in the transmit path, for instance. The first local oscillator 362 may also be coupled to the observation receiver 364 feeding the first oscillation signal to the observation path. In the case of a predistortion transmitter, for instance, the first oscillation signal is fed to the observation receiver in a normal operation mode in which amplifier predistortion is compensated for. Correspondingly, the second transmit path 370 includes a first local oscillator 372, which may feed the first oscillation signal to the second observation receiver 374. Although FIG. 3 shows only two pairs of transmitters and observation receivers, there may be more of them in the transmitter 300.

FIG. 3 also shows a second local oscillator 380. The second local oscillator 380 may feed a second oscillation signal either to the first observation receiver 364 or a second observation receiver 374. Practically, generation of a compensation signal for compensation of a leakage signal happens fairly seldom, and therefore the second local oscillator may be applied time divisionally as a shared resource between several observation receivers.

FIG. 4 shows on a more detailed level an embodiment of a predistortion compensation unit 410, or more generally a compensation unit. The unit inputs a signal to be transmitted from the left and forwards it over to a DAC 412. An observation signal is received from the observation path in the inversion unit 450. In a first operation mode, the inversion unit receives the distortion caused by the power amplifier in the transmit path, and in a second operation mode, the inversion unit receives an oscillation leakage signal. The inversion unit may generate digitally for each sample an inverse sample, which nulls the sample received from the observation receiver when summed with it.

The compensation unit may include or be coupled to two databases, a predistortion database 452 including a compensation signal with respect to different amplifying values of the power amplifier, and a leakage signal compensation database 454. Instead of databases, the compensation values may also be stored in lookup tables, for instance.

In a predistortion transmitter, the compensation of the predistortion may be applied continuously. In a first operation mode, the transmitter measures the predistortion and applies the compensation signal online. In this mode, the inversion unit 450 may update the predistortion values to the database if they have changed, and forward them to a summing unit 456 to be applied online to the incoming signal for compensation of the predistortion. However, in a second operation mode, when the transmitter generates an LO leakage compensation signal, the predistortion compensation signal is not available online. The controlling unit 458 may then, during the generation of an LO leakage compensation signal, order the summing unit to read the predistortion compensation values from the table/database 452. Typically the second mode, that is calculation of a leakage compensation signal, takes only a few milliseconds.

In the first operation mode, the compensation unit compensates for the LO leakage by reading the current LO leakage compensation values from the table/database 454. Updating of the LO leakage compensation signal may be needed when the environmental conditions, such as temperature, for instance, of the apparatus change.

Thus, practically, the apparatus may be most of the time in the first operation mode when the predistortion compensation signal is generated online, and an LO leakage compensation signal is read from memory such as a table or a database. The second operation mode is applied fairly seldom, and during the mode the predistortion compensation signal may be read from the memory, and the new LO leakage compensation signal is written to the memory.

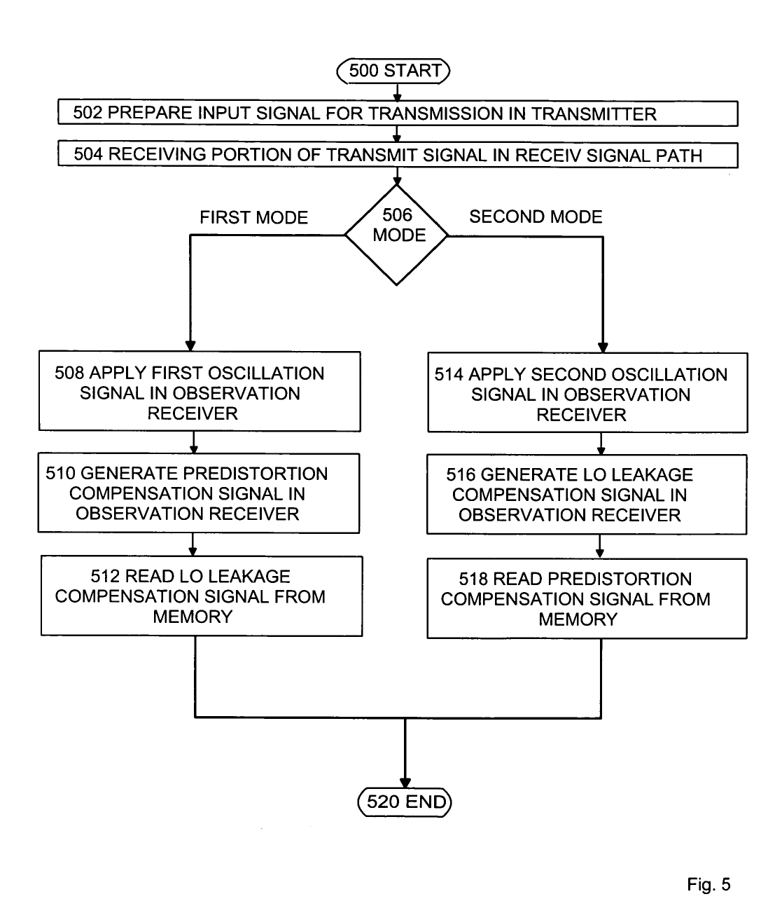

FIG. 5 shows an embodiment of a method. In 502, a transmit signal is generated from an input signal in a transmit path of the transmitter. A radio frequency signal is generated from the input signal by mixing the input signal with a first oscillation signal. In 504, a portion of the radio frequency signal is received in an observation receiver of the transmitter.

The extracted signal portion may include several signal components, such as one on a centre frequency of the local oscillator, and a signal component on an LO leakage frequency of the first oscillation signal. The LO leakage depends on an IQ imbalance of the transmitter components.

In 506, the method branches on the basis of an operation mode of the transmitter. The first mode denotes a normal operation mode of a transmitter. In the case of a predistortion transmitter, the normal mode means online generation of a predistortion compensation signal. The second mode means a mode in which an LO leakage compensation signal is generated and a predistortion compensation signal is read from memory.

In 508, the observation receiver uses a first oscillation signal, which may be generated by the same first local oscillator that also feeds the transmit path. The transmit signal conveyed to and processed by the observation receiver will thus be on a band-pass frequency of the observation receiver, whereby frequency components outside the centre frequency of the transmit band (such as a leakage component of the first local oscillator) will be filtered out. In 510, a compensation signal for compensation of the distortion will be generated. As shown by 512, during the first mode LO leakage is compensated for using a compensation signal read from a memory.

In the second operation mode in step 514, the observation receiver uses a second oscillation signal whereby the LO leakage signal component in the extracted transmit signal portion is shifted onto a band-pass frequency of the observation receiver. In a first embodiment, the second oscillation signal is generated from a first oscillation signal by performing an additional mixing step. In another embodiment, a separate second oscillator is provided specifically for generating the second oscillation signal.

In 516, the LO leakage signal is on a band-pass frequency of the observation receiver, whereby the observation receiver is capable of generating a compensation (inverse) signal of the LO leakage signal. During the second mode, the predistortion compensation signal is read from memory as shown by step 518.

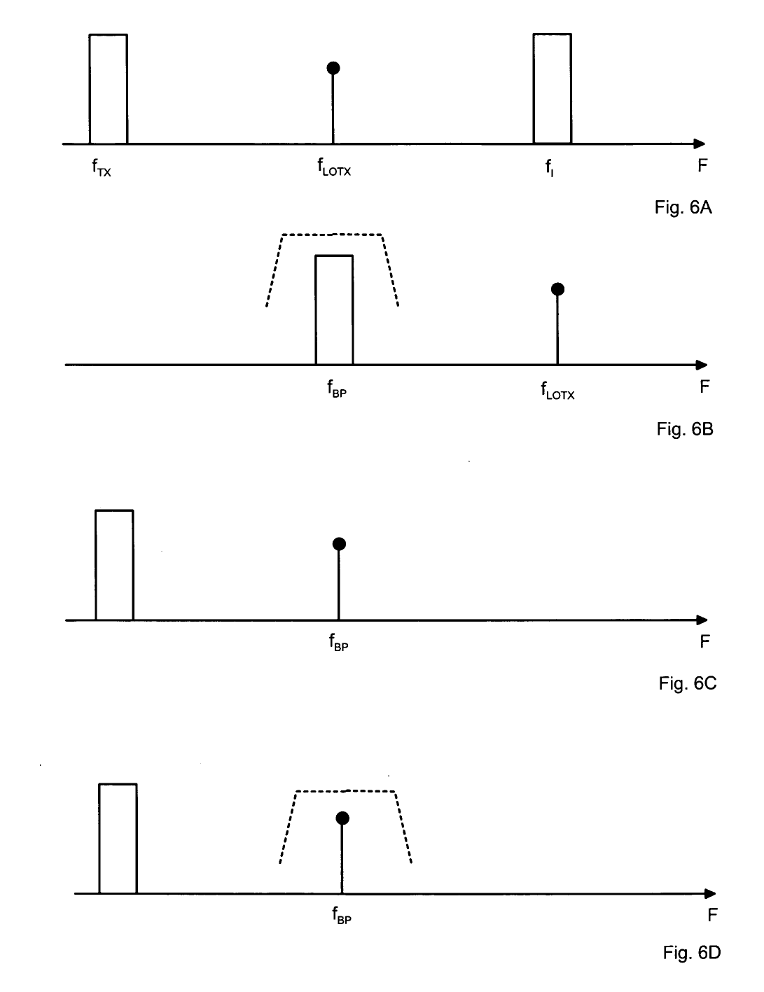

FIGS. 6A to 6D illustrate the frequency shifting procedure of the present invention. In all the figures, frequency F is shown on the x-axis.

FIG. 6A shows the situation in the transmit path after an input signal has been mixed to a transmit frequency F(Tx). By way of an example, we may consider a situation in a WCDMA-transmitter. In a WCDMA-transmitter, an input data signal to the mixing phase may be on an intermediate frequency f_{IF}. The local oscillation signal (that is the first oscillation signal) may be on a frequency f_{LOTX}. The wanted signal will be on a frequency f_{TX} (f_{LOTX}−f_{IF}) shown in FIG. 6A with f_{TX}. A leakage signal component f_{LOTX} is present in the transmit signal on the frequency of the oscillator, that is f_{LOTX}. An image component of the wanted transmit signal is on a image frequency f, (f_{LOTX}+f_{IF}).

FIG. 6B shows the situation where the transmit signal has been conveyed to and processed in the observation receiver. This is the operation in the first operation mode of the transmitter that is the predistortion cancellation mode (or some other observation mode), where a portion of the transmit signal is observed in the observation path. f_{BP} denotes the band-frequency of a band-pass filter of the observation path.

FIG. 6C illustrates a situation where a frequency shift has been applied to the transmit signal in the observation path. As it is known that the leakage component is on the frequency f_{LOTX}, to shift it to a frequency of the observation receiver (f_{BP}), the frequency of the second oscillation signal f_{LO2} should be for example f_{LOTX}−f_{IF} being thus different from the frequency of the first oscillation signal. Thus, because the frequency of the leakage signal is known in the transmit path, a constant frequency shift may be applied to the transmit signal spectrum.

In FIG. 6D, the leakage signal, which is on a band-pass frequency of the observation path, is passed on and the actual transmit signal becomes filtered away. The leakage signal is then A/D converted and an inverse compensation signal is generated from the converted digital signal.

Embodiments of the invention or parts of them may be implemented as a computer program comprising instructions for executing a computer process for implementing the method according to the invention.

The computer program may be stored on a computer program distribution medium readable by a computer or a processor. The computer program medium may be, for example but not limited to, an electric, magnetic, optical, infrared, or semiconductor system, device or transmission medium. The computer program medium may include at least one of the following media: a computer readable medium, a program storage medium, a record medium, a computer readable memory, a random access memory, an erasable programmable read-only memory, a computer readable software distribution package, a computer readable signal, a computer readable telecommunications signal, computer readable printed matter, and a computer readable compressed software package.

Other than computer program implementation solutions are also possible, such as different hardware implementations (entities or modules), such as a circuit built of separate logics components or one or more client-specific integrated circuits (Application-Specific Integrated Circuit, ASIC). A hybrid of these implementations is also feasible.

It will be obvious to a person skilled in the art that, as the technology advances, the inventive concept can be implemented in various ways. The invention and its embodiments are not limited to the examples described above but may vary within the scope of the claims.

1. An apparatus, comprising:
a first local oscillator configured to generate a first oscillation signal;
a first mixer configured to generate a transmit signal by mixing an input signal and the first oscillation signal;
an observation receiver configured to:
receive a portion of the transmit signal,
apply, in a first operation mode of the apparatus, the received portion of the transmit signal in the observation receiver such that a transmit signal component on a frequency of the first oscillation signal present in the received portion of the transmit signal falls into a band-pass frequency of the observation receiver, and
shift, in a second operation mode of the apparatus, the received portion of the transmit signal such that an oscillation leakage signal component of the first oscillation signal present in the received portion of the transmit signal falls into the band-pass frequency of the observation receiver;
a compensator configured to generate a compensation signal based on the band-pass signal of the observation receiver for compensation of the input signal.

2. An apparatus according to claim 1, wherein the observation receiver comprises:
a second mixer configured, in a first operation mode of the apparatus, to mix the received portion of the transmit signal with the first oscillation signal.

3. An apparatus according to claim 1, wherein the observation receiver comprises:
a second mixer configured, in a second operation mode of the apparatus, to mix the received portion of the transmit signal with a second oscillation signal having a frequency different from the frequency of the first oscillation signal.

4. An apparatus according to claim 1, wherein the observation receiver comprises:
a band-pass filter having a band-pass frequency defining the band-pass frequency of the observation receiver.

5. An apparatus according to claim 1, wherein the observation receiver comprises:
a second local oscillator configured to generate a second oscillation signal different from the frequency of the first oscillation signal;
a second mixer configured, in a first operation mode of the apparatus, to mix the received portion of the transmit signal with the first oscillation signal, and in a second operation mode of the apparatus, to mix the received portion with the second oscillation signal; and
a mechanism configured to couple the second mixer to the first local oscillator in the first operation mode, and to the second local oscillator in the second operation mode.

6. An apparatus according to claim 5, wherein the mechanism comprises a switch.

7. An apparatus according to claim 1, wherein the apparatus comprises a memory storage configured to store a compensation signal for compensation of the oscillation leakage signal of the first local oscillator, and the compensator is configured to read the compensation signal for compensation of the oscillation leakage signal of the first local oscillator from the memory storage during the first operation mode of the apparatus.

8. An apparatus according to claim 1, wherein the apparatus comprises a plurality of observation receivers, and a second local oscillator shared by the plurality of observation receivers in a time-shared manner to provide the second oscillation signal for different observation receivers.

9. An apparatus according to claim 1, wherein the compensator is configured to generate a compensation signal for compensation of predistortion caused by a power amplifier positioned between the first mixer and the observation receiver.

10. An apparatus according to claim 9, wherein the apparatus comprises a memory storage configured to store a compensation signal for compensation of the predistortion of the power amplifier, and the compensator is configured to read the compensation signal for compensation of the predistortion from the memory storage during the second operation mode of the apparatus.

11. An apparatus according to claim 1, wherein the observation receiver comprises:
a second mixer configured to mix the received portion of the transmit signal with a second oscillation signal having a frequency different from the frequency of the first oscillation signal;
a band-pass filter configured to filter the signal outputted by the second mixer; and
an analog to digital converter configured to generate digital samples of the signal filtered by the band-pass filter.

12. An apparatus according to claim 1, wherein the apparatus is further configured to operate as a part of a base station of a radio system.

13. An apparatus, comprising:
generating means for generating a first oscillation signal;
transmit signal generating means for generating a transmit signal by mixing an input signal and the first oscillation signal;
receiving means for receiving a portion of the transmit signal;
applying means for applying, in a first operation mode of the apparatus, the received portion of the transmit signal in the observation receiver such that a transmit signal component on a frequency of the first oscillation signal present in the received portion of the transmit signal falls into a band-pass frequency of the observation receiver;
shifting means for shifting, in a second operation mode of the apparatus, the received portion of the transmit signal such that an oscillation leakage signal component of the first oscillation signal present in the received portion of the transmit signal falls into the band-pass frequency of the observation receiver; and
compensation signal generating means for generating a compensation signal on the basis of the band-pass signal of the observation receiver for compensation of the input signal.

14. An apparatus according to claim 13, further comprising:
oscillation signal generating means for generating a second oscillation signal on a frequency different from the frequency of the first oscillation signal;
first mixing means for mixing, in a first operation mode of the apparatus, the received portion of the transmit signal with the first oscillation signal; and
second mixing means for mixing, in a second operation mode of the apparatus, the received portion of the transmit signal with the second oscillation signal, and
coupling means for coupling the mixing means to the generating means in the first operation mode, and to the oscillation signal generating means in the second operation mode.

15. An apparatus according to claim 13, further comprising:
storing means for storing a compensation signal for compensation of the oscillation leakage signal of the first local oscillator;
reading means for reading the compensation signal for compensation of the oscillation leakage signal of the first local oscillator from the memory storage during the first operation mode of the apparatus.

16. An apparatus according to claim 13, further comprising:
a plurality of observation receivers; and
sharing means for sharing the second oscillation signal between the plurality of observation receivers in a time-shared manner.

17. An apparatus according to claim 13, further comprising:
storing means for storing a compensation signal for compensation of the predistortion of the power amplifier;
reading means for reading the compensation signal for compensation of the predistortion from the memory storage during the second operation mode of the apparatus.

18. A method, comprising:
generating a first oscillation signal;
generating a transmit signal by mixing an input signal and the first oscillation signal;
receiving a portion of the transmit signal in an observation receiver;
applying, in a first operation mode, the received portion of the transmit signal such that a transmit signal component on a frequency of the first oscillation signal present in the received portion of the transmit signal falls into a band-pass frequency of the observation receiver;
shifting, in a second operation mode of the apparatus, the received portion of the transmit signal such that an oscillation leakage signal component of the first oscillation signal present in the received portion of the transmit signal falls into the band-pass frequency of the observation receiver; and
generating a compensation signal based on the band-pass signal of the observation receiver for compensation of the input signal.

19. A method according to claim 18, further comprising:
storing a compensation signal for compensation of the oscillation leakage signal of the first local oscillator;
reading the compensation signal for compensation of the oscillation leakage signal of the first local oscillator from the memory storage during the first operation mode of the apparatus.

20. A method according to claim 18, further comprising:
providing a single source of a second oscillation signal;
sharing the second oscillation signal between a plurality of observation receivers in a time-shared manner.

21. A method according to claim 18, further comprising:
storing a compensation signal for compensation of the predistortion of the power amplifier;
reading the compensation signal for compensation of the predistortion from the memory storage during the second operation mode of the apparatus.

22. A computer program embodied on a computer readable medium and encoding instructions for performing a method, the method comprising:
generating a first oscillation signal;
generating a transmit signal by mixing an input signal and the first oscillation signal;
receiving a portion of the transmit signal in an observation receiver;
applying, in a first operation mode, the received portion of the transmit signal such that a transmit signal component on a frequency of the first oscillation signal present in the received portion of the transmit signal falls into a band-pass frequency of the observation receiver;
shifting, in a second operation mode of the apparatus, the received portion of the transmit signal such that an oscillation leakage signal component of the first oscillation signal present in the received portion of the transmit signal falls into the band-pass frequency of the observation receiver; and
generating a compensation signal on the basis of the band-pass signal of the observation receiver for compensation of the input signal.

23. The computer program of claim 22, wherein the computer-readable medium comprises one or more of a program storage medium, a record medium, a computer readable memory, a computer readable software distribution package, a computer readable signal, a computer readable telecommunications signal, and a computer readable compressed software package.
